(19) United States
(12) Patent Application Publication
(10) Pub. No.: US 2024/0108980 A1
(43) Pub. Date: Apr. 4, 2024

(54) METHOD, APPARATUSES AND SYSTEMS DIRECTED TO ADAPTING USER INPUT IN CLOUD GAMING

(71) Applicant: InterDigital CE Patent Holdings, SAS, Paris (FR)

(72) Inventors: Christoph Neumann, Rennes (FR); Charles Salmon-Legagneur, Rennes (FR); Franck Aumont, Vern sur Seiche (FR); Charline Taibi, Chartres de Bretagne (FR)

(21) Appl. No.: 18/274,893

(22) PCT Filed: Jan. 20, 2022
(86) PCT No.: PCT/EP2022/051166

§ 371 Date: Jul. 28, 2023

(30) Foreign Application Priority Data
Jan. 28, 2021 (EP) 21305110.5

(51) Int. Cl. A63F 13/355; A63F 13/358

(52) U.S. Cl. CPC A63F 13/355; A63F 13/358; A63F 2300/538

(57) ABSTRACT

Methods, apparatuses, systems, etc., directed to adapting user input in cloud gaming are disclosed herein. In an embodiment, a consumption rate of a game running on a game server may be obtained (e.g., by a client device). For example, the consumption rate may be associated with at least one input device (e.g., of the client device). For example, a consumption rate may be representative of a rate at which the game server may process user inputs of the (e.g., associated) input device. For example, the input rate (e.g., at which the user inputs may be transmitted to the game server) may be adapted by synchronizing the input rate to the consumption rate.

### 1. TECHNICAL FIELD

The present disclosure relates to the cloud gaming domain, which may also be referred to as game streaming.

### 2. BACKGROUND ART

In cloud gaming, an end user device may not run the game executable program, which may be run on a server (e.g., instance). User inputs may be captured by the end-user device and sent to the server (e.g., instance) via a network. The resulting user experience of the game may vary depending on different factors such as e.g., network latency, server load and game complexity. The present disclosure has been designed with the foregoing in mind.

### 3. SUMMARY

Methods, apparatuses, systems, etc., directed to adapting user input in cloud gaming are disclosed herein. For example, video frames of a game, running on a cloud server, may be received by a client device. In an embodiment, consumption rate information associated with a game running on a game server may be obtained (e.g., received) by a client device. For example, consumption rate information may be associated with (e.g., received input information from) at least one input device (e.g., of the client device). For example, consumption rate information may be representative of a velocity (e.g., a rate) at which the game server may react to (e.g., process) user inputs of (e.g., received input information from) the (e.g., associated) input device. For example, the input rate (e.g., at which the user inputs may be transmitted to the game server) may be adapted based on the received consumption rate information (e.g., by synchronizing the input rate to the consumption rate).

Although various embodiments are described and/or claimed herein in which an apparatus, system, device, etc. and/or any element thereof is configured to carry out an operation, process, algorithm, function, etc. and/or any portion thereof, it is be understood that any embodiments described and/or claimed herein assume that any apparatus, system, device, etc. and/or any element thereof carries out any operation, process, algorithm, function, etc. and/or any portion thereof (and vice versa).

### 4. BRIEF DESCRIPTION OF THE DRAWINGS

A more detailed understanding may be had from the following description, given by way of example in conjunction with the accompanying drawings. FIGS. in such drawings, like the detailed description, are examples. As such, the Figures and the detailed description are not to be considered limiting, and other equally effective examples are possible and likely. Furthermore, like reference numerals in the figures indicate like elements.

FIG. 1 is a system diagram illustrating an example of a high-level architecture of a game streaming;

FIG. 2 is a system diagram illustrating two system architecture examples of respectively a standalone and a cloud gaming system;

FIG. 3 is a diagram illustrating an example of a joystick input state;

FIG. 4 is a system diagram illustrating an example of an input management in a cloud server instance;

FIG. 5 is a diagram illustrating two examples of performances of a game at two different times;

FIG. 6 is a diagram illustrating an example of user action queuing;

FIG. 7 is a diagram illustrating an example of software probes that may be installed in the input management system;

FIG. 8 is a diagram illustrating an example of client device input rate adaptation;

FIG. 9A is a diagram illustrating an example of a client device for adapting an input rate of at least one input device;

FIG. 9B represents an example of an architecture of the client device of FIGS. 9A and 9C;

FIG. 9C is a diagram illustrating an example of a cloud server configured to run a game in interaction with a client device;

FIG. 10 is a diagram illustrating an example of a method for adapting an input rate of at least one input device of a client device;

FIG. 11 is a diagram illustrating an example of a method implemented in a client device; and

FIG. 12 is a diagram illustrating an example of a method implemented in an instance of a cloud server.

It should be understood that the drawing(s) are for purposes of illustrating the concepts of the disclosure and are not necessarily the only possible configuration for illustrating the disclosure.

### 5. DESCRIPTION OF EMBODIMENTS

It should be understood that the elements shown in the figures may be implemented in various forms of hardware, software or combinations thereof. Preferably, these elements are implemented in a combination of hardware and software on one or more appropriately programmed general-purpose devices, which may include a processor, memory and input/output interfaces. Herein, the term “interconnected” is defined to mean directly connected to or indirectly connected with through one or more intermediate components. Such intermediate components may include both hardware and software based components. The term “interconnected” is not limited to a wired interconnection and also includes wireless interconnection.

All examples and conditional language recited herein are intended for educational purposes to aid the reader in understanding the principles of the disclosure and the concepts contributed by the inventor to furthering the art and are to be construed as being without limitation to such specifically recited examples and conditions.

Moreover, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read only memory (ROM) for storing software, random access memory (RAM), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

Embodiments described herein are related to cloud gaming which may also be referred to as game streaming. Cloud gaming may be seen as the concept of executing a game on a (e.g., remote) server, which may be referred to herein as any of a game server and a cloud server, and sending the result as a video stream to an end-user device, which may be referred to herein as any of a cloud gaming client, a thin client device, a client game device, collectively client device. The game server and the client device may be interconnected via any type of network. For example, the server may be located in the cloud and the game may be running on any (e.g., type of) instance of a server. The terms game server, cloud server and instance of a cloud server may be used interchangeably throughout embodiments described herein to designate the (e.g., containerized) processing environment (e.g., circuitry) that may be used to execute a game in interaction with a client device.

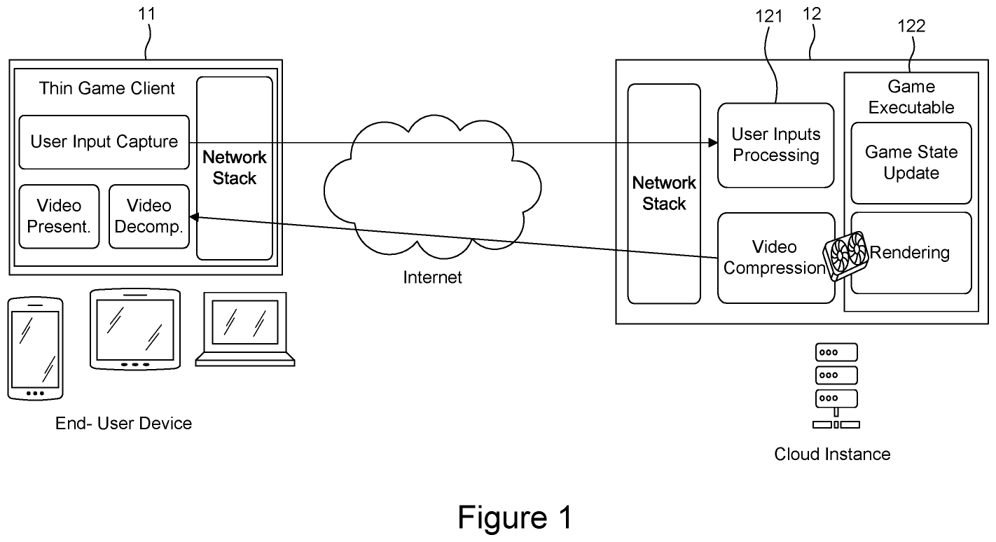

FIG. 1 is a system diagram illustrating an example of a high-level architecture of a game streaming. The client device 11 may not run the game executable, which may be running on a game server 12. The client device 11, may (e.g., run a thin client application that may) receive (e.g., capture) user inputs, such as e.g., any of mouse events, keypad commands and keyboard keys that may have been pressed. Throughout embodiments described herein, the terms “user inputs” and “received input information” may be used interchangeably to designate any kind of input information that may be received from an input device of a client device 11, and that may be associated with (e.g., directed to) a game running on a game server 12. The client device 11 may transmit (e.g., stream) these user inputs to the game server 12. The client device 11 may decode and display video frames of a video stream, that may be received from the game server 12. The client device 11, by performing (e.g., only) these few operations may be lightweight (include limited processing resources). The term “video stream” is used to designate the set of video (e.g., encoded) frames of the game that may be transmitted by the game server to the client device, including e.g., any of a transport layer overhead and (e.g., corresponding) metadata.

For example, for a (e.g., each) client device, a (e.g., dedicated) server instance may run the game executable. The server instance may run, for example, in a data centre (that may be operated e.g., by any of a cloud provider and an operator). The server instance may be associated (e.g., equipped) with (e.g., performant, specific) hardware and, for example, may have access to a graphics processing unit (GPU). For example, a game executable 122 running on the game server may poll at an (e.g., internal, gaming) polling-rate user inputs that may have been previously received by the user input processing module 121. For example, the game state may be updated based on received user inputs and the scene may be rendered accordingly. The server may regularly obtain (e.g., capture) the scene e.g., rendered by the GPU, which may result in a flow of (e.g., uncompressed) images, which may be encoded into a (e.g., live) video stream which may be sent to the client device.

According to embodiments, the consumption of the input commands by the game may be complex to predict and may depend, for example, on any of the inner game engine, the game itself and the scene where the player may be located at a (e.g., given) time. For example, the scene complexity (e.g., and density) may vary and the processing on the server may depend on the resources (e.g., any of disk I/O accesses, CPU, GPU, memory, . . . ) that may be available at this time. The available resources may be variable depending on the resource allocation for e.g., other services (e.g., any of other game instances, video streaming, . . . ).

In a game environment, the quality of experience (QoE) of a game may be impacted by any number of parameters. The quality of experience may be degraded and may become uncomfortable for the human brain. One of the QoE impacting parameters may be the responsiveness of the system to react to the user's commands (which may also be referred to herein as perceived latency). This parameter may depend, for example, on the input management process which may be more deterministic in the case of a game in a local standalone system than in a cloud gaming system.

In a cloud gaming system, where the game server and the client device may not be localized at the same place, enabling that the control commands may “arrive at the right moment” to be ingested by the game for being processed according to its current state may be complex to achieve. For example, ingest of input commands, from the user, on the (e.g., thin) game client device may be decoupled from the polling of inputs that may be performed by the game executable on the server. For example, the input command processing at the client device may be desynchronized and not performed at the same polling rate than the input command processing at the game server. This may induce jitter. Jitter may also be induced by the network, which may not happen in the case where the game is played on a standalone device (e.g., any of a console, a mobile device, and a gaming PC).

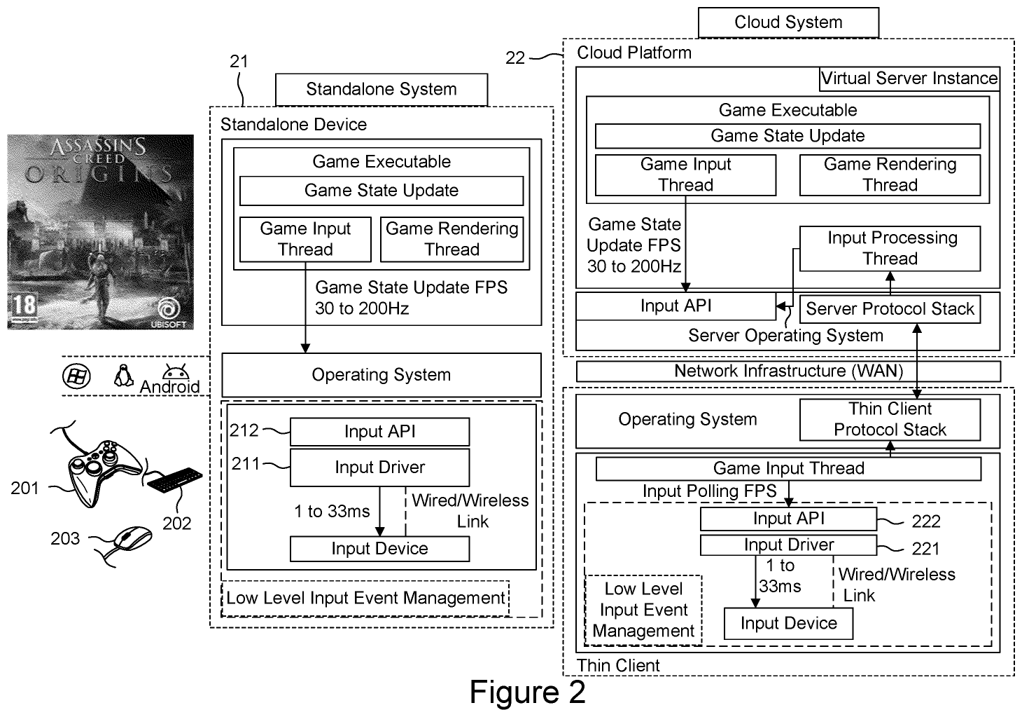

FIG. 2 is a system diagram illustrating two system architecture examples of respectively a standalone and a cloud gaming system. More precisely, FIG. 2 shows entities (e.g., software modules) that may be involved in the input management of respectively a standalone and a cloud gaming system.

Example of Low-Level Input Event Management

As illustrated in FIG. 2, low-level input event management may involve an input of any an input driver 211, 221 and an INPUT application programming interface (API) 212, 222 of any of a standalone 21 and a cloud gaming 22 system.

For example, the input driver 211, 221 may (e.g., provide an) interface to any number of (e.g., physical) input device(s) 201, 202, 203 (e.g., any of a joystick, a mouse, a keyboard). The input driver 211, 221 may (e.g., constantly) poll the input device state at a (e.g., variable) physical device rate, that may depend, for example, on any of the physical link (e.g., 125 Hz to 500 Hz) and the hardware capabilities of the input device(s) 201, 202, 203, which may e.g., create a different input lag. For example, a gaming (e.g., steelseries) mouse may have an input lag between one and two milli seconds. In another example, a (e.g., common Microsoft wired) keyboard (e.g., 600) may have an input lag of 33 ms. In yet another example, a joystick (e.g., steelseries stratus duo) may have an input lag less than one milli second.

For example, an INPUT API 212, 222 may allow to obtain (e.g., gather, retrieve) the (e.g., last) input state that may have been received by the driver and to make it available to the application. Xinput may be an example of an input system API, for x360 joystick. For example, the INPUT API 212, 222 may be packaged in a (e.g., third party) higher level abstraction API such as e.g., simple direct media layer (SDL), e.g., a multiple platform API available on any of win32/64, Linux and Android.

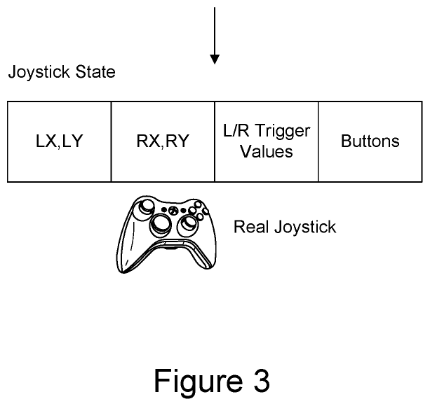

FIG. 3 is a diagram illustrating an example of a joystick input state which may comprise a structure, for example, including the state (e.g., any of pressed and released of any joystick button). The joystick input state may include four axis LX, LY, RX, RY values and (e.g., L/R) trigger digital values (e.g., from 0 to 255).

Example of Game Engine, Input and Rendering Threads

For example, a game engine may be configured to obtain (e.g., collect) inputs from input devices via e.g., an input thread. Inputs may be obtained in any of a polling model and an event model. In the polling model the input thread may obtain the state of input devices by e.g., calling a (e.g., userland system) INPUT API 222, at a (e.g., fix) game polling rate. In the event model, the input thread may wait for input events that may be posted by the operating system (e.g., the INPUT API 222).

For example, the game engine may be configured to perform an (e.g., infinite) loop within a rendering thread. At a (e.g., each) loop iteration, the game state may be updated based on e.g., the last inputs that may have been obtained by the input thread. The scene may be rendered (e.g., and/or copied), for example, in (e.g., to) the frame buffer e.g., through the GPU. In a first example, the rendered scene may be displayed on a screen in a standalone system. In a second example, the rendered scene may be transmitted over a network for being displayed by a (e.g., thin) client device in a cloud system. The number of iterations that may be performed per second may produce a (e.g., varying) frame rate, which may be referred to herein as frame per second (FPS). A FPS may be comprised between e.g., five frames and two hundred frames per second, depending on any of the GPU power, the (e.g., current) complexity of the game scene, the synchronization with the display frequency (which may be referred to herein as VSYNC) for standalone system and the game settings (e.g., targeted FPS).

In a (e.g., specific) game engine architecture example, the input polling may be (e.g., directly) included in the rendering thread. It may be a design choice to use a (e.g., single) rendering thread for the game engine, that in an (e.g., each) iteration of the rendering loop, may poll input states (e.g., once), for example, before computing the frame. This design choice may be motivated by the fact that asynchronous polling at a rate greater than the rendering rate may not provide additional benefit, as the user may not have more visual feedback on screen to his commands at this higher rate. Any game engine design choice (e.g., not limited to polling the input state once per rendering frame) may be applicable to embodiments described herein.

Example of Cloud Level Input Event Management

A game executable (e.g., provided by a game editor) may run in a server instance, for example, in an unmodified way (e.g., as it may be running in a standalone device). The low-level input event management, e.g., seen from the game engine perspective, may be based on the same input API (e.g., XINPUT API) as for a standalone system.

For example, the low-level input event management may include a (e.g., new) input processing module and injector module(s) in the instance for receiving (e.g., remote) events from the network and for injecting them to the (e.g., running) game. A (e.g., virtual) input device may be emulated for a (e.g., given) server instance according to any of a push model and a pull model.

In a push model example, the input API injector module may post events to the underlying operating system message loop, for example, using Win32 events API. For example, the server instance may push (e.g., send) events to the operating system at a (e.g., server ingest) rate, without knowing (e.g., and controlling) when these events may be processed (e.g., effectively consumed) by the game executable through e.g., the call of an input API.

In a pull model example, the input API injector module may intercept (e.g., some of) the input API that may be called by the game executable and may return (e.g., fake the returned) results of the system call. The pull model may be, for example, linked to the input polling rate of the game executable. Detouring mechanisms (such as e.g., Microsoft Detours interception library) may allow to bypass calls to the input driver so that the input API may not access any (e.g., physical) input device anymore.

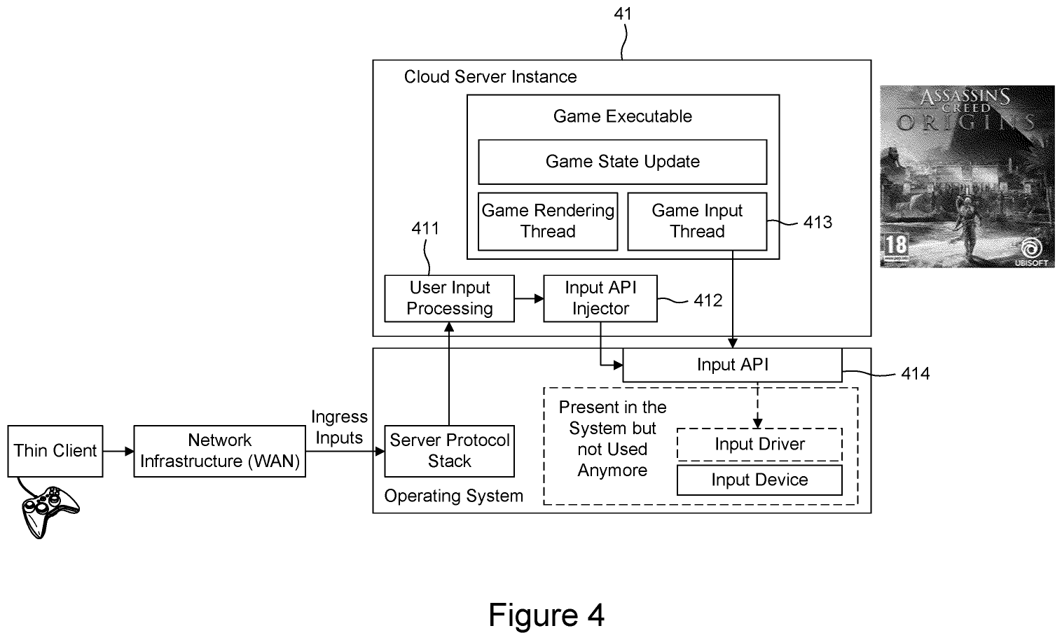

FIG. 4 is a system diagram illustrating an example of an input management in a cloud server instance. A user input processing 411 entity (e.g., module) may listen to (e.g., the arrival of the) input commands (e.g., information) from the network and may push them into e.g., an internal (e.g., first in first out (FIFO)) queue. The game input thread 413 may (e.g., continue to) poll the input commands e.g., using the INPUT API 414 as it may proceed in a standalone system. At a (e.g., each) polling, the INPUT API may interact with the input API injector module 412 (through e.g., any of legacy events sending functions and API interception). The input API injector module 412 may pop (e.g., obtain, receive, extract) an input command from the (e.g., FIFO) queue and may reinject it to the system, based on any of the push and the pull model.

Example of a (e.g., Thin) Client Device According to embodiments, the (e.g., thin) client device may comprise an input management module that may be similar to the input management module of a standalone client device (e.g., FIG. 2 left part). The (e.g., thin) client device (e.g., executable) may poll inputs from any number of input devices (e.g., a joystick) at a (e.g., fixed) polling rate. In a case where there are more than one input devices, the input devices may be polled at any of a same polling rate and different polling rates. According to embodiments, the input states that may have been obtained (e.g., captured) from the input device(s) may be sent to the user input processing module of a cloud server instance via a network (e.g., through any of a transport control protocol (TCP) and a user datagram protocol (UDP) socket). Different cloud gaming providers may use different polling rates. For example, it may be measured that GeForceNow polls inputs at the average rate of 60 events per second, that Stadia polls inputs at the average rate of 200 events per second, and that Blacknut Stadia polls inputs at the average rate of 100 events per second.

Network Transport Protocol Examples

In a cloud system, the (e.g., user) inputs not being processed (e.g., consumed) by the game locally may be sent by the (e.g., thin) client device to the cloud server instance running the game by using any type of transport protocol (such as e.g., any of TCP, UDP, . . . ).

For example, TCP may be used in order to enable a reliable transmission, e.g., by avoiding any loss of user input during transmission. In a degraded network, TCP may introduce additional latency issues due to retransmission. For example, TCP may have non-deterministic performances, which may impact the perceived latency.

In another example, UDP may be used to provide more deterministic latency. For example, some packets/commands may be lost, which may also impact the game experience. Any of applicative retransmissions of packets and forward error correction (FEC) may allow to improve reliability but may also introduce latency and may increase the throughput (e.g., number of packets per second).

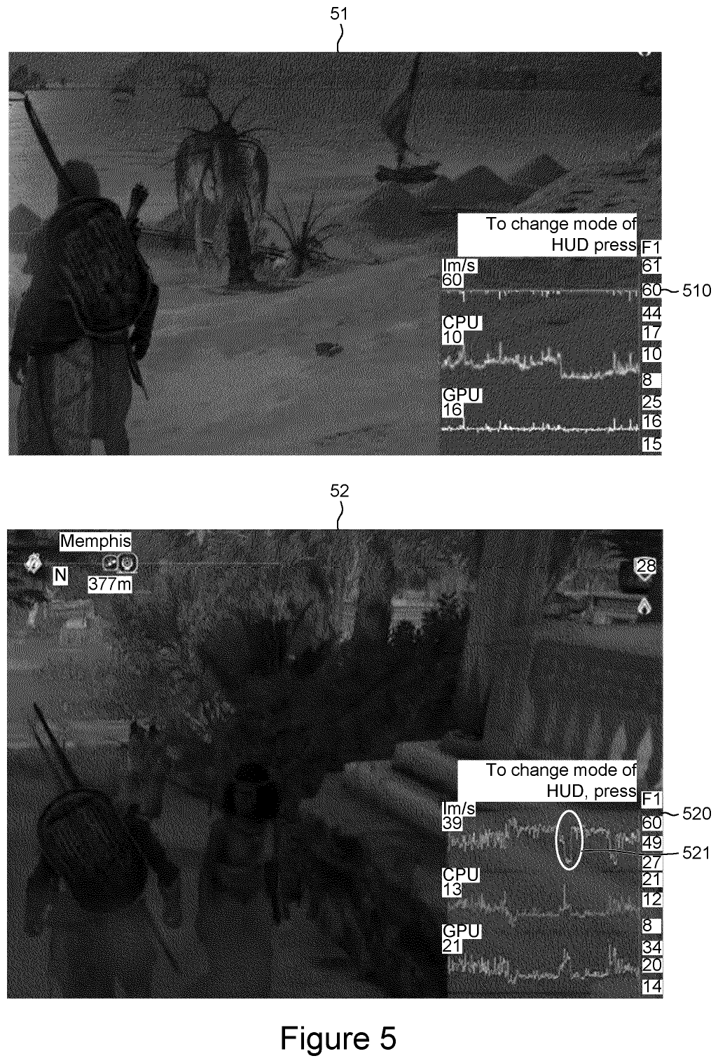

FIG. 5 is a diagram illustrating two examples of performances of a game at two different times. The game which performances are illustrated in FIG. 5 is Assassin'Creed Odyssey (ACO) running on a cloud gaming platform. The terms “game frame rate”, “FPS game”, “FPS”, collectively “FPS” may be used interchangeably in embodiments described herein to refer to a number of frames of the game that may be rendered per second (e.g., on a GPU) by the game engine on the game server. The FPS in a gaming session may not be constant over time. In a case where the scene is not GPU demanding, as shown on the top 51, the GPU may succeed in maintaining a steady FPS 510 of 60 images per second (the lm/s top line on the graph). In a case where the scene is more GPU demanding (e.g., in more complex scenes), as shown on the bottom 52, depending on any of user position, eye's direction and world scene live events, the FPS 520 may be unstable and may drop 521, e.g., below 27 images per second.

In ACO, according to the game engine design, the joystick input (e.g., polling) rate in the game server may follow the (e.g., current) FPS of the game. It may be observed (e.g., measured) that the joystick responsiveness may be sensitive to the FPS variations. In a case where the game FPS is getting low (FIG. 5 bottom 52), the user may experience more input lag. When the joystick is released, the avatar may still be moving on screen for e.g., hundreds of milliseconds. The input lag may not be constant which may further degrade the user experience. For example, a varying input lag may increase the difficulty for the user to predict any of moves and muscle memory.

The network may also contribute to the input lag by e.g., adding a transport delay (e.g., from 5 to 30 ms) which may be (e.g., much) less noticeable than the input lag variation due to varying FPS.

Example of Temporal Inconsistency between the Game Engine Input Consumption and End-User's Actions

As illustrated with the ACO example, there may be inconsistencies (e.g., desynchronization, variations) in a cloud gaming system between the time end-user's actions may be generated and the time they may treated by the game engine. This inconsistency may be related to the queuing of input events in the server instance.

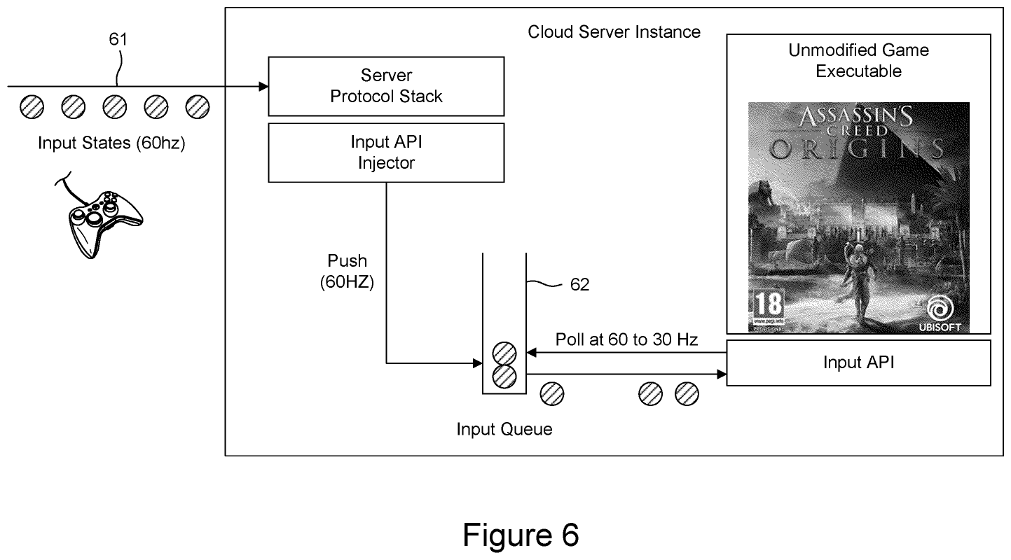

FIG. 6 is a diagram illustrating an example of user action queuing. For example, based on user actions, the client device may send input events 61 (e.g., states) at a (e.g., 60 Hz) fixed rate. The input events 61 may be received by the server protocol stack and inserted in an (e.g., internal) queue 62 at e.g., the same rate. The game engine may process (e.g., consume) the input events at, for example, a lower rate that may be synchronized to the game frame rate (e.g. varying from 60 to 30 Hz), which may result in an overflow of the queue 62. Lack of temporal alignment may happen, for example, in a case where the game engine processes (e.g., consumes all) those buffered input events e.g., until there may be no more pending event in the queue 62. For example, the time the event may be presented to the engine may be shifted by the amount of time the event may have spent in the queue 62. A varying (e.g., erratic) queuing time may prevent the user actions and their presentation time in the game to behave (e.g., vary) in a similar way. A varying (e.g., erratic) queuing time may (e.g., significantly) increase the perceived latency by e.g., hundreds of milliseconds which may be annoying for the user experience. In embodiments, described herein, this problem will be referred to as temporal inconsistency.

Example of Game Engine Input Consumption Variation Input consumption may vary for various reasons. As illustrated in the ACO example, the input consumption may vary based on inner factors related to the game logic such as e.g., the fluctuation of the scene complexity. More generally, input overflow may occur for any reason that may limit the cloud instance activity. On a deployed cloud gaming infrastructure, causes for input consumption variations may include any of the resource sharing between different instances, the number of simultaneous connected players on a server and the management of physical resources (e.g., any of the memory, GPU cores, the CPU utilization, I/O bottlenecks, the available network bandwidth per user etc.).

The reception of input events on the game server from the client device may depend, for example, on the network constraints (e.g., performances), that may not be stable (e.g., constant). Varying network performances may introduce any of latency, jitter, and loss of packets, for example, due to network congestions. For example, bursts of packets may induce overflow of the input queue. In another example, late arrival of packets may induce input queue underflow (e.g., lack of responsiveness of the game to user actions).

Adapting User Input in Cloud Gaming

Embodiments described herein may allow to deliver the control commands (e.g., user actions, input events, received input information) to the game server for being processed by (e.g., ingested to) the game at a presentation time, that may correspond to (e.g., be aligned, synchronized with) the input consumption rate of the game. For example, the presentation time may correspond to a rendered frame. Embodiments described herein may allow to reduce and stabilize the perceived latency. For example, control command buffering may remain limited and the input rate (e.g., at which the user inputs may be polled), may behave (e.g., vary) over time in a similar way as (e.g., according to) the game engine consumption rate during the game session.

According to embodiments, the (e.g., thin) client device input rate may be adapted to the consumption rate (e.g., value) of (e.g., a game running on) the game server. The consumption rate (e.g., information, value) may be associated with one of any number of input devices (e.g., of the client device). For example, the consumption rate (e.g., information, value) may be representative of a velocity (e.g., a rate) at which the (e.g., game running in the) game server may react to (e.g., process) user inputs of (e.g., received from) the input device. For example, the (e.g., thin) client device may synchronize with the consumption rate (e.g., value) any of its input (e.g., polling) rate and the sending rate (e.g., the rate at which the corresponding information may be sent to the game server). The synchronization may allow, for example, that the input events may be consumed by the game executable at the same speed (e.g., rate) as the one at which they may be generated on the client input device. The synchronization may allow, for example, to keep the size of the event buffer at the server side (e.g., relatively) limited. The synchronization may allow, for example, to reduce (e.g., minimize) the queuing delay and the related perceived latency.

The adaptation of the input rate to the consumption rate (e.g., value) may be complex to obtain for several reasons. For example, the consumption rate of the game server may vary during the game session. In another example, there may be no access available to the code of the game that may allow to obtain (e.g., measure) any metric related to the consumption rate from inside the game engine (e.g., the game executable may be seen as a black box). In yet another example, the evolution (e.g., variation) of the consumption rate may result from a (e.g., large) set of (e.g., diverse) parameters (e.g., factors) and may be complex to predict.

According to embodiments, the input rate may be set to a fix value that may correspond to a low (e.g., minimum) frame rate that may be used in the game engine. This may allow to prevent any overflow of the (e.g., internal) input queue. For example, a low (e.g., minimum) frame rate of a game may be as low as 30 frame per second (fps). Setting the input rate at a constant value of 30 event per second may be acceptable for simple games based on low input rates but may be less acceptable for more complex games as it may degrade the gaming experience of games where higher input rates would improve the game experience.

Example of User Input Adaptation Based on Temporal Alignment

According to embodiments, the consumption rate (e.g., information, value) of the game (e.g., executable) may be obtained (e.g., monitored) by e.g., the game server (e.g., instance). For example, information related to (e.g., indicating) the consumption rate may be (e.g., explicitly) transmitted to the client device. In a first example, this information may be encapsulated in metadata in e.g., the video (e.g., transport) stream. In another example, the information indicating the consumption rate of the game may be sent (e.g., directly) to the (e.g., thin) client device by any of (e.g., dedicated) proprietary and a standard protocol. For example, the information indicating the consumption rate of the game may be transmitted on a regular basis. In another example, the information indicating the consumption rate of the game may be transmitted (e.g., only) in a case where a change (e.g., of any metric impacting the rate at which the game server may process user inputs) has been detected. Information indicating the consumption rate may be referred to herein as consumption rate information.

According to embodiments, the information indicating the consumption rate of the game may be sent to the client by, for example, the game server. In another example, the game server may transmit any information related to the consumption rate to another (e.g., monitoring, production) server, which may (e.g., process and) transmit the information indicating the consumption rate of the game to the client device.

According to embodiments, the information indicating the consumption rate of the game may include (e.g., indicate) any input consumption metrics that may be obtained by the server for being sent to the client device, a FPS metric that may be returned (e.g., transmitted) by the server to the client.

According to embodiments, the input rate of (e.g., an input device) of the client device may be synchronized to the consumption rate (e.g., value) of the game, based on the received information. For example, the consumption rate (e.g., value) of the game (with which the input rate of an input device may be synchronized), may be determined, at the client device, based on metrics included in consumption rate information and received from any of the cloud server and a monitoring server. In another example, the consumption rate (e.g., value) of the game (with which the input rate of an input device may be synchronized), may be determined at any of the cloud server and the monitoring server and may be transmitted to the client device, for example, in consumption rate information.

According to embodiments, the client device may synchronize the input (e.g., polling) rate of an input device with the game frame rate e.g., without receiving any explicit information on the consumption rate from the game server. For example, the client device may determine the consumption rate (e.g., value) of the game (with which the input rate of an input device may be synchronized) based on receiving and decoding the video frames received from the cloud server. This synchronization may be performed (e.g., continuously, regularly) for taking into account any variation of the game engine frame rate. For example, the client device may synchronize the input (e.g., polling) rate with the frame start indicator within e.g., the transport packet of the video stream of the game. In another example, the client device may obtain (e.g., extract) the FPS information from the video decoder and may synchronize its input (e.g., polling) rate with the obtained FPS information. Any technique for obtaining an FPS information from a video decoder receiving (e.g., decoding) a video may be applicable to embodiments described herein.

Example of User Input Adaptation Based on Prediction

According to embodiments, the latency between the client device and the game server may vary (e.g., over time) due to any number of varying parameters (e.g., networking, processing (e.g., capture, encode, decode) and rendering). In a case where the latency variation is large, the internal event queue in the game server may be any of filled up and drained before the client device may have been able to adapt any of the input (e.g., polling) rate and the sending rate.

Embodiments described herein may allow to improve the robustness of the temporal alignment between the user inputs and the consumption rate by (e.g., tracking and) anticipating a consumption rate variation of the game (e.g., engine). For example, any of the input (e.g., polling) and sending rates may be adapted by the client device based on an anticipated (e.g., estimated) variation of the consumption rate.

According to embodiments, the input polling rate of a game executable may be predicted, for example, using any of input consumption rate metrics, FPS metrics and machine learning algorithms, e.g., based on any of past and crowd sourced (e.g., experiences) data. For example, the consumption rate (e.g., variation) may be obtained (e.g., predicted) by processing the (e.g., generated) game (e.g., video) frames in e.g., a neural network.

According to embodiments, the prediction (e.g., module) may be running on any of the client device and the game server e.g., for improving the accuracy. In a case where the consumption rate variation is predicted by the game server, the predicted (e.g., anticipated) consumption rate (e.g., variation, drop, increase) may be transmitted to the client device e.g., ahead of time of the (e.g., real) variation. The message that may be transmitted to the client device may comprise (e.g., indicate), for example, any of a (e.g., predicted) input polling rate an indication (e.g., warning) of a (e.g., probable, future) variation (e.g., drop/increase) with an expected value of the consumption rate. For example, the game server may send this message at least one round trip time (RTT) in advance of the variation.

According to embodiments, after receiving an indication of a predicted consumption rate (e.g., variation), the client device may adapt (e.g., vary, increase, decrease) any of the input polling rate and the sending rate. According to embodiments, the client device may perform a (e.g., local) prediction of the consumption rate variation, and may adjust any of the input polling rate and the sending rate accordingly.

According to embodiments, the client device may receive (e.g., additional, performance) metrics from the game server, such as e.g., any of GPU, CPU and disk load. For example, the client device may use this information to refine the game consumption prediction. In another example, the client device may send some information to the game server to improve its prediction algorithm.

According to embodiments, any of the refinement process and predictions may be based on a pre-trained model that, for example, may be distributed to any of game clients and game servers.

Embodiments described herein may allow to keep any of the input (e.g., polling) and sending rates at client device behaving (e.g., varying) in a similar way as the (e.g., input) consumption rate at the server side, during the (e.g., whole) game session. Embodiments described herein may allow the input command buffer at the server to remain at a (e.g., proper) level without overflowing (without any loss of command).

Example of Event Monitoring in the Scope of the Game Executable

According to embodiments, the client device may receive an (e.g., explicit) information indicative of a consumption rate of the game running in the game server. According to embodiments, the client device may obtain (e.g., determine) the consumption rate (e.g., value) based on the received (e.g., explicit) information.

According to embodiments, the game server (e.g., instance) may monitor any of the input consumption rate and the FPS of an (e.g., unmodified) game executable (e.g., that may be seen as a black box). For example, the game editor may provide a library to expose this piece of information. In a case where no such library is available, an interception technique (e.g., Microsoft Detour SDK) may be used on an operating system API to obtain (e.g., collect) this information e.g., without modifying the game code.

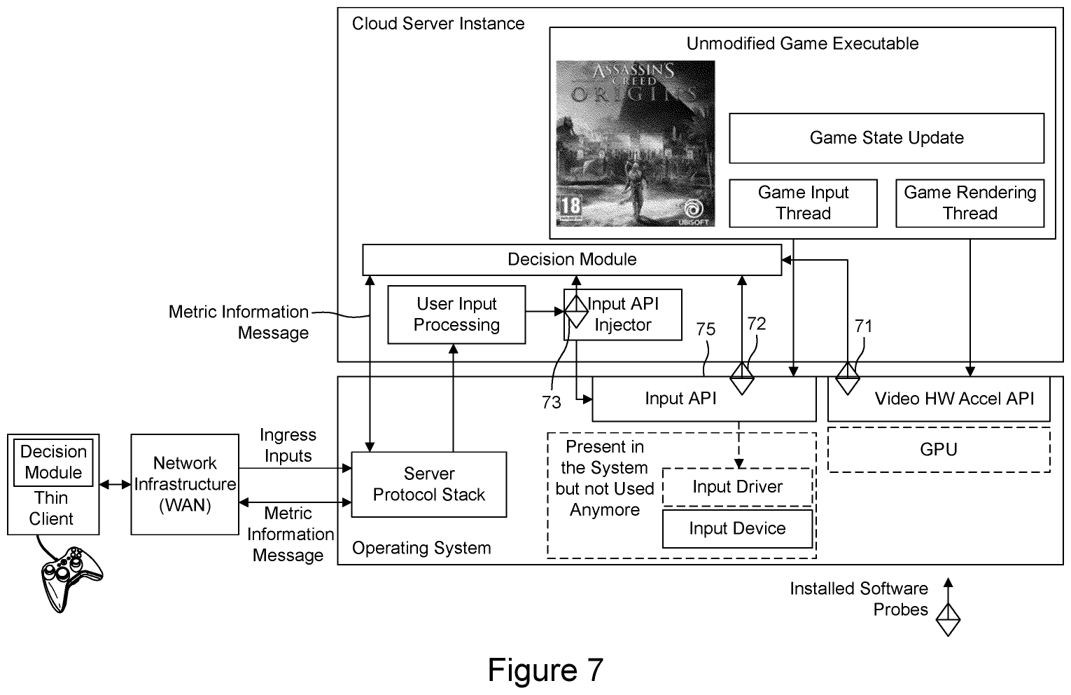

FIG. 7 is a diagram illustrating an example of software probes that may be installed in the input management system. For example, at the initialization, an (e.g., unmodified) game executable may be launched in memory (e.g., by the game server instance). For example, software probes 71, 72, 73 may be installed on (e.g., a list of) API functions from system shared libraries, that may be loaded statically or dynamically by the game e.g., during execution. In a case where an API function (e.g., on which a software probe 71, 72, 73 may have been installed) is called (e.g., triggered), the game server instance may be notified by the software probes 71, 72, 73. The game server instance may record the time of the API function call for computing an (e.g., average) rate and e.g., obtaining a trend.

According to embodiments, at least an input consumption rate (which may be referred to herein as consumption_rate_{game}) and a game frame rate (which may be referred to herein as FPS_{game}) may be obtained (e.g., by the game server and transmitted to the client device) from the execution of the game.

For example, the input consumption rate (consumption_rate_{game}) may be the frequency (e.g., rate) at which an input event (e.g., received input information) may be consumed (e.g., processed) by the game e.g., through the INPUT API 75. This frequency may depend on the input device that may be used by the gamer (e.g., joystick, keyboard, mouse) and on the game engine architecture (e.g., design choices). According to embodiments, the input consumption rate (consumption_rate_{game}) may be obtained for game engines whose input management may follow any of a polling and an event-based model. The server instance may use software probes 72 on any of the input polling API (e.g., XINPUT) and the system messaging functions (e.g., system functions that may peek any of an input event and a raw input device event). In a case where a third-party abstraction API is used (e.g., SDL), software probes may be put on the messaging functions within this API.

For example, the game frame rate (FPS_{game}) may be the number of frames rendered, per second, on the GPU by e.g., the game rendering thread. For example, the game frame rate (FPS_{game}) may be obtained via a software probe 71 that may be set on the hardware acceleration API function (e.g., any of DirectX and OpenGL) that may swap the content of the back buffer with the front buffer on screen. This function that may be called (e.g., once) at (e.g., each) iteration of the render loop, e.g., once per frame may allow to obtain the game frame rate.

Example of Monitoring the Server Frame Rate

According to embodiments, the server frame rate (which may be referred to herein as (FPSₛₑᵣᵥₑᵣ), may be obtained (e.g., monitored) by the game server (e.g., instance). The server frame rate (FPSₛₑᵣᵥₑᵣ) may be the number of frames per second from the video encoder perspective. For example, a (e.g., capture) API may be used (e.g., DXGI API) for capturing frames to be encoded. The capture API may trigger, for example, any of a capture on a system and a GPU notification event. The (e.g., current) time of the capture may be used, for example, as a measure of the server frame rate.

Example of Information Delivered by the Game Server to the Client Device

According to embodiments, a (e.g., consumption rate) information indicating (e.g., representative of) a velocity (e.g., rate) at which the game server may react to (e.g., user) inputs of an input device may be received by the client device from the game server. For example, the (e.g., consumption rate) information may comprise (e.g., indicate) any of an input consumption rate (consumption_rate_{game}), a game frame rate (FPS game), a server frame rate (FPSₛₑᵣᵥₑᵣ) and a filing ratio (IQ_FILL_RATIO) of an input queue that may be associated with the game. For example, the (e.g., consumption rate) information may comprise a time value (e.g., a timestamp indicating the time of any of a (e.g., last) input event processing and a (e.g., last) frame rendering). For example, the (e.g., consumption rate) information may include (e.g., indicate) a value (e.g., a function) of any of the corresponding metric (e.g., consumption_rate_{game}, FPS_{game}, FPSₛₑᵣᵥₑᵣ, IQ_FILL_RATIO) over e.g., a sliding window. For example, the value (e.g., the function) may be any of a combination, an average, a median, a maximum, a minimum and percentiles (e.g., over any of a time interval and a sliding window) of any of the metrics. For example, the (e.g., consumption rate) information may include a predicted value for any of the above-mentioned metric (e.g., consumption_rate_{game}, FPS_{game}, FPSₛₑᵣᵥₑᵣ, IQ_FILL_RATIO). The predicted value may be obtained, for example, via regression analysis. Any technique for predicting a value based on a set of previous values may be applicable to embodiments described herein.

According to embodiments, the (e.g., consumption rate) information may be transmitted any of regularly, periodically, a-periodically (e.g., after a value change) . . . . For example, the time interval between two subsequent (e.g., consumption rate) information transmissions may be less than a frame duration (e.g., 16 ms for 60 fps). The (e.g., consumption rate) information may be encapsulated (e.g., transmitted) in, for example, any of a TCP and an UDP packet. Considering that the volume of information may remain limited (e.g., 60 IP packets per second), the throughput for transmitting the information may remain less than 200 kbit/s.

According to embodiments, the (e.g., consumption rate) information may be transmitted (e.g., only) in a case where (e.g., any metric that may be included in) the consumption rate information varies. For example, the transmission may be based on a hysteresis e.g., to avoid generating too many messages towards the client device.

According to embodiments, the (e.g., consumption rate) information may be transmitted to the client device by different techniques. For example, the information may be sent (e.g., directly) to the client device in e.g., any of an UDP and a TCP data stream (e.g., connection). In another example, the information may be encapsulated in a metadata of the (e.g., transport) video stream. For example, the frame timestamp may be inserted in the metadata of the transport packet format (e.g., real time protocol (RTP) header) that may carry the encoded frame. In yet another example, the information may be piggybacked with (e.g., included, added to) other control message reports that may rely on packet count (such as e.g., real time control protocol (RTCP) reports).

According to embodiments, (e.g., user action) commands may be piggybacked in (e.g., included, added to) ack messages that may be sent for (e.g., each) received video packet, for example, in the case of the secure reliable transport (SRT) protocol.

Example of Adaptation of the Client Device Input Rate

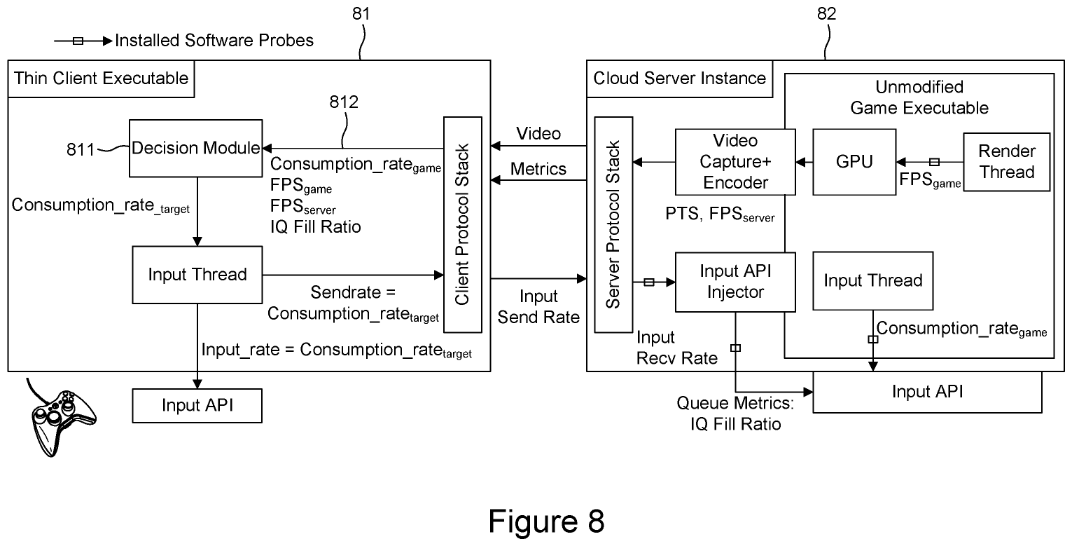

FIG. 8 is a diagram illustrating an example of client device input rate adaptation. According to embodiments, a decision module 811 may be listening on the client device 81 to the metrics 812 that may be received from the game server 82 (e.g., via the network). The information 812 may be received, for example, in any of a specific data stream, a report stream, and embedded metadata of the video (e.g., transport) stream.

For example, the decision module 811 may obtain (e.g., calculate) a (e.g., target) consumption rate (which may be referred to herein as Consumption_rate_{target}) based on the received information. For example, the (e.g., target) consumption rate (Consumption_rate_{target}) may be equal to any one of the received rate information (e.g., any of Consumption_rate_{game}, FPS_{game}, and FPSₛₑᵣᵥₑᵣ) In another example, the (e.g., target) consumption rate (Consumption_rate_{target}) may be obtained as a function of any one of the received (e.g., rate) information (e.g., any of Consumption_rate_{game}, FPS_{game}, and FPSₛₑᵣᵥₑᵣ, IQ_FILL_RATIO). For example, different rate information (e.g., values) may be received for a same rate metric (e.g., any of Consumption_rate_{game}, FPS_{game}, and FPSₛₑᵣᵥₑᵣ), the (e.g., target) consumption rate (Consumption_rate_{target}) may be a function of the different values, e.g., any of an average, a median, a maximum, a minimum, and percentiles of the different values. In yet another example, different (e.g., rate) information (e.g., values) may be received for respectively different metrics (e.g., any of Consumption_rate_{game}, FPS_{game}, FPSₛₑᵣᵥₑᵣ, IQ_FILL_RATIO), the (e.g., target) consumption rate (Consumption_rate_{target}) may be a function of the different values of the different metrics, e.g., any of an average, a (e.g., linear) combination, a median, a maximum, a minimum, and percentiles of the different values. Throughout embodiments described herein the terms “consumption rate value” and “Consumption_rate_{target}” may be used interchangeably to designate the (e.g., estimated) rate at which the cloud server may process received input information, and with which the input rate of the input device may be synchronized.

In another example (not illustrated), the decision module may be located at any of the cloud server and the monitoring server. For example, the (e.g., target) consumption rate (Consumption_rate_{target}) may be determined at any of the cloud server and the monitoring server. For example, the (e.g., target) consumption rate (Consumption_rate_{target}) may be included in the consumption rate information that may be transmitted to the client device (e.g., by any of the cloud server and the monitoring server).

According to embodiments, any of the input polling rate (e.g., of an input device) and the sending rate of the client device may be adjusted to the (e.g., target) consumption rate (Consumption_rate_{target}).

For example, the input rate (e.g., of an input device) of the client device may be controlled (e.g., adjusted) by e.g., instantiating an (e.g., input) thread in the client device, following a polling model. For example, the (e.g., input) thread may poll (e.g., in an infinite loop) the state of the input device at a variable time interval, that may be adjusted to the (e.g., target) consumption rate (Consumption_rate_{target}). The polled input state may be sent to the game server, for example in an uplink user command stream.

Adjusting the input polling rate to the (e.g., target) consumption rate (Consumption_rate_{target}) may allow to deliver user command packets to the network at a rate (e.g., frequency) that may vary according to the (e.g., current) input consumption rate of the game.

Example of Improvement for Game Server Following an Input Model

According to embodiments, the game server may follow (e.g., perform) an input polling model. For example, the game server may comprise an (e.g., internal) input queue (e.g., associated with the game) that may be processed as described by FIG. 6. For example, input states may be received from the client device and may be pushed in the (e.g., internal) input queue, e.g., by the input injector API. One entry (e.g., an event item) may be popped from the (e.g., internal) input queue at (e.g., each) call on the input function by the game executable. At (e.g., each) INPUT API invocation, any of the invocation time of the INPUT API, the fill ratio of the input queue (which may be referred to herein as IQ_FILL_RATIO), and the number of pending events that may not have not been consumed yet may be stored (e.g., logged). The fill ratio of the input queue may be, for example, the number elements (e.g., events) in the queue divided by the capacity (e.g., size) of the queue.

For example, the fill ratio of the input queue may be representative of the temporal alignment (e.g., similarity, synchronization) between the client input rate and the consumption rate, e.g., taking (e.g., also) into account the impact of network constraints.

According to embodiments, the fill ratio of the input queue may be included (e.g., indicated) in the information (e.g., indicative of the consumption rate) that may be transmitted to the client device for being processed by the decision module. For example, transmitting an indication of the fill ratio of the input queue may allow to provide additional indication (e.g., feedback) on potential congestions. Transmitting an indication of the fill ratio of the input queue may also allow to improve prediction, by taking into account factors that may be external to the game server instance, (e.g., related to what may happen between the client device and the game server instance).

According to embodiments, the client device (e.g., decision module) may adapt any of its input (e.g., polling) rate and sending rate accordingly. In a non-limiting example, in a case where the fill ratio of the input queue is increasing e.g., above a first (e.g., threshold) value, the client device may (e.g., decide to) decrease any of its polling and sending rates. In a case where the fill ratio of the input queue is decreasing e.g., under a second (e.g., threshold) value, the client device may (e.g., decide to) increase any of its polling and sending rates. Any technique for adapting any of its polling and sending rates based on the fill ratio of the input queue may be applicable to embodiments described herein.

Example of Temporal Alignment Performed by the Client Device without Server Indication

According to embodiments, the client device may obtain a consumption rate of the game e.g., without receiving any (e.g., explicit) information from the game server indicative of the consumption rate. For example, the client device may be able to infer metrics on the game server instance behaviour, for example, in a case where the video capture bitrate on the game server instance follows the game frame rate (FPS game) e.g., the ingress video bitrate may reflect the (e.g., real, effective) FPS of the game. For example, the consumption rate (e.g., value) may be obtained by the client device based on a frame rate at which video frames of the game may be any of received, presented, decoded and displayed by the client device.

According to embodiments, the client device may obtain (e.g., predict, estimate) the input consumption rate on the basis of a client frame rate that may be obtained (e.g., evaluated) on the client device (which may be referred to herein as FPS_{client}). For example, the client frame rate (FPS_{client}) may be obtained using the video packet time arrival that may be deduced from the frame start indicator within the transport packet of the video stream. In another example, the client frame rate (FPS_{client}) may be obtained based on (e.g., presentation) time stamps that may be embedded in metadata of the encoded video, and that may indicate at which times the different video frames may be presented (e.g., rendered) by the client device.

According to embodiments, the client device may receive (e.g., light) acknowledgement packets that may be sent by the game server for acknowledging reception of sent packets (e.g., that may include user command packets). For example, a congestion (e.g., problem) may be detected by monitoring the reception of acknowledgement packets. For example, the congestion may be detected in a case where acknowledgement packets are any of delayed and lost. For example, detecting a congestion may allow the client device (e.g., decision module) to lower the obtained (e.g., target) consumption rate to be used for input rate adaptation.

Example of Consumption Rate Prediction on the Client Device

According to embodiments, the client device may obtain a prediction of the consumption rate based on metrics that may be provided by the server. For example, the predicted consumption rate may be representative of a predicted rate at which the game server may process further user inputs e.g., at a future point in time (e.g., in a future time interval). For example, the client device may obtain the prediction via a prediction function that may be referred to herein as f(X)=Y, where X may be any metric received from the server and Y may be the predicted consumption rate. For example, the prediction function may be performed in the decision module of the client device.

According to embodiments, the prediction may be obtained based on a history of consumption rate information (e.g., X may be the history of consumption rate information). The history may comprise metric values for e.g., the last 30 seconds. Any technique for defining a history of (e.g., past) values may be applicable to embodiments described herein. According to embodiments, the history (X) may comprise values of any of the input consumption rate and (e.g., any of client, server, game) frame rates.

According to embodiments, the client device may (e.g., continuously, regularly) adjust any of its input polling and sending rates, based on (e.g., to be equal to) the predicted consumption rate.

Example of Consumption Rate Prediction on the Game Server

According to embodiments, the game server may obtain a prediction of the consumption rate based on metrics, that may be obtained (e.g., collected), for example within the game server. For example, the predicted consumption rate may be representative of a predicted rate at which the game server may process further user inputs e.g., at a future point in time (e.g., in a future time interval). For example, a prediction function f(X)=Y (e.g., as described above) may be used by the game server. For example, (e.g., all) metrics X may be locally available (e.g., in the game server), and the game server may obtain (e.g., compute) its predictions based on these metrics. For example, the game server may use any of its current (e.g., server, game) frame rate values, GPU, CPU and disk load to obtain a predicted (e.g., future) input consumption rate. For example, the game server may compare the predicted (e.g., input) consumption rate with the current (e.g., input) consumption rate. The game server may notify the client (by e.g., transmitting a notification message) indicating whether the predicted (e.g., input) consumption rate may differ from the current one. According to embodiments, the (e.g., notification) message may include any of the predicted consumption rate (e.g., Y), an indication of a change to occur (e.g., any of increase and drop), a variation (e.g., difference of value) to occur, a time information indicating when the prediction may be applicable. Any technique and message format for indicating a predicted consumption rate to the client device may be applicable to embodiments described herein.

Example of Prediction Functions

Prediction functions (f(X)=Y) that may be used by any of the client device and the game server to predict the consumption rate are described herein. X may represent input metrics that may be provided by e.g., the game server. Y may represent the predicted consumption rate. According to embodiments, the prediction may be associated with any (e.g., different) time horizons (e.g., intervals).

In a first example, Y may be a (e.g., single) value, which may correspond to a prediction of the consumption rate at the server, that may occur, for example an amount of time t ahead of the time relative to the time last input metric may have been produced. For example, the prediction window (e.g., amount of time t) may correspond to the (e.g., current, mean maximum) RTT. For example, the prediction window (e.g., amount of time t) may be any of fixed, pre-configured, and dynamically configurable.

In a second example, Y may be a n-tuple (n being any integer value), that may include at least a value of the predicted consumption rate, a date at which the predicted consumption rate may be applicable, and validity duration (e.g., of the prediction).

In a third example, Y may be a vector that may describe a time series of consumption rate at the server at different (e.g., discrete) time intervals, for example, relative to the last metric received from the server. Indicating a predicted consumption rate as a time series (e.g., different predicted values for different future time periods) may allow the client device to obtain (e.g., pick) a predicted consumption rate corresponding to the (e.g., currently observed) RTT.

According to embodiments, the prediction function f may be any of a (e.g., linear) regression function, an auto-regressive integrated moving average (ARIMA) model, and a machine learning model according to any machine learning technique.

For example, a (e.g., linear) regression function may be applied to the history of (e.g., past) consumption rates of any of the current gaming session and other gaming sessions.

For example, an ARIMA model may (e.g., solely) rely (e.g., be based) on the history of (e.g., past) consumption rates of the current gaming session. An ARIMA model may allow to avoid any preliminary training of the model. For example, an ARIMA model may not take into account other metrics and may not learn from other game sessions (e.g., of other users).

For example, a machine learning (ML) model may be used for any of regression and time series prediction. The ML model may be based, for example, on any of decision trees (e.g. random forests, gradient decision boosted trees . . . ) and (e.g., deep) neural networks (using e.g. convolutional networks on time series or images, gated recurrent units (GRUs), recurrent neural networks (RNNs), long short term memories (LSTMs), fully connected layers . . . ). A machine learning model may have been trained using metrics generated and collected during, for example, other game sessions (e.g. during any of the game development phase, a beta deployment phase, a game deployment phase (e.g., using accumulated data of an online gaming service)). The ML model may be trained (e.g. and generated) based on collected training data. The trained ML model may be deployed on any of the client device and the game server to perform the consumption rate prediction. Training data may include, for example, the (e.g., input) consumption rate (corresponding to the Y). Training data may include, for example, other metrics and data such as any of (e.g., game, server, client) frame rate values, GPU load, CPU load, disk load and the generated video stream itself. Convolutional neural networks may be be used, for example, to extract features from the video stream itself. For example, the ML Model may be deployed on the client device, which may have access to the same type of metrics during inference time. On the client device, the (e.g., same type of) metrics may be used, for example, to improve (e.g., refine, train) the deployed ML model.

According to embodiments, any of the client device and the game server may use as any of a complementary and a standalone method, a reinforcement learning method to determine any of the input (e.g., polling) rate and the sending rate.

According to embodiments, a training module may be colocalized on any of the game server and another network element (e.g., a third entity). In a case where the training module is located in another network element, the training may be realized offline.

According to embodiments, the training may be realized offline and the obtained model may be refined e.g., online in any of the client device and the game server.

Example of Prediction Improvement in the Client Device

According to embodiments, the client device may use a ML model (e.g., based on any of decision trees and neural networks) to obtain a prediction of e.g., the user input. The client device may receive (e.g., additional internal) server metrics from the game server, based on which the client device may e.g., refine prediction models. For example, the server may send any of the GPU, the CPU and the disk load to the client device.

According to embodiments, a ML model may be (e.g., regularly) updated for including e.g., any of a more recent and a more generic model. For example, the ML (e.g., prediction) model may be received by the client device from any of the game server and another network element (e.g., a third entity/service). For example, the ML model may be updated by updating the game executable in the client device e.g., via any software update mechanisms.

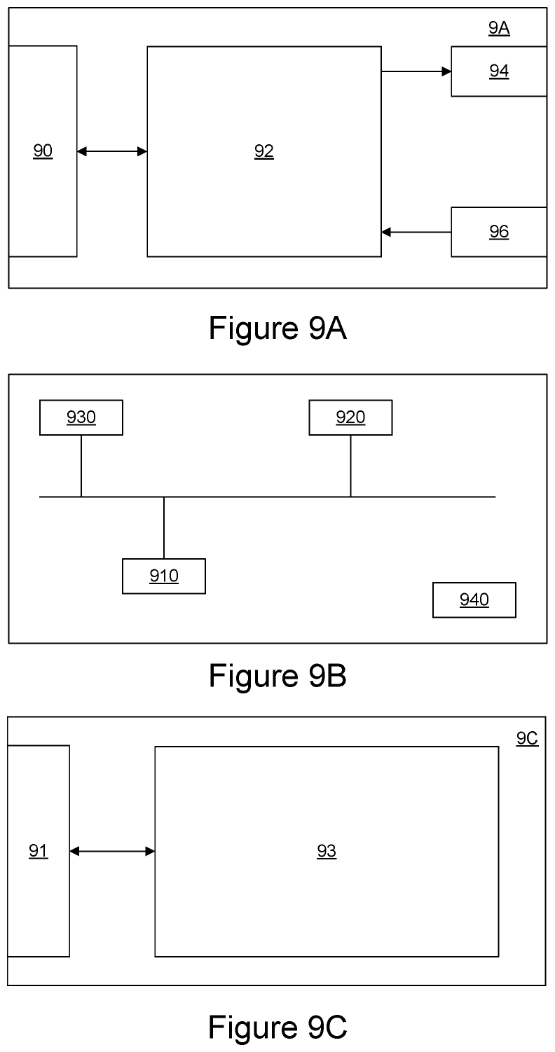

FIG. 9A is a diagram illustrating an example of a client (e.g., processing) device 9A for adapting an (e.g., user) input rate of at least one input device. For example, the processing device 9A may comprise a cloud gaming (e.g., thin) client that may interact with a game server. For example, the processing device 9A may comprise an input interface 96 configured to receive (e.g., user) input information (e.g., indicating commands) from any number of input devices (such as e.g., any of a joystick, a mouse, a keyboard, . . . ). The commands may be destinated to the game server. For example, the processing device 9A may comprise a network interface 90 for connection to a network. The network interface 90 may be configured to send packets to a game server. A packet may include, for example, an (e.g., user) input commands that may be received from at least one input device. For example, the network interface 90 may be configured to receive a video stream from the game server. The video stream may contain video frames of the game to be decoded and displayed by the client (e.g., processing) device 9A. For example, the network interface 90 may be configured to receive information related to the consumption rate at the game server from any of the game server and a monitoring server. For example, the network interface 90 may be configured to receive consumption rate information associated with the running game. For example, the consumption rate information may be associated with received input information from at least one input device of the client device and may be representative of a rate at which the game server may process the received input information from the at least one input device. According to embodiments, the network interface 90 may be any of:
a wireless local area network interface such as Bluetooth, Wi-Fi in any flavour, or any kind of wireless interface of the IEEE 802 family of network interfaces;
a wired LAN interface such as Ethernet, IEEE 802.3 or any wired interface of the IEEE 802 family of network interfaces;
a wired bus interface such as USB, FireWire, or any kind of wired bus technology.
a broadband cellular wireless network interface such a 2G/3G/4G/5G cellular wireless network interface compliant to the 3GPP specification in any of its releases;
a wide area network interface such a xDSL, FFTx or a WiMAX interface.

More generally, any network interface allowing to send (e.g., user input) commands of a game and receive a video stream of the game may be applicable to embodiments described herein.

According to embodiments, the network interface 90 may be coupled to a processing module 92, that may be configured to obtain (e.g., receive) a consumption rate (e.g., information) associated with (e.g., a game running on) a game server. For example, the consumption rate (e.g., information may be associated with one of the at least one input device. For example, the consumption rate (e.g., information) may be representative of a velocity (e.g., rate) at which the game server may react to (e.g., process) user inputs of the one of the at least one input device. The processing module 92 may be further configured to adapt the input rate at which the user inputs may be transmitted to the game server based on the received consumption rate (e.g., information) e.g., by synchronizing the input rate to a consumption rate value. The processing module 92 may be further configured to receive video frames of the game from the game server, to decode and send the video frames for display on a video output 94 such as a display means. According to embodiments the display means may be external to the device and the video output 94 may send the video to display to an external display means. According to embodiments, the display means, internal or external, may be any of a personal computer screen, a TV screen, a tablet screen, a smartphone screen. More generally any display means allowing to display a video of a game may be applicable to embodiments described herein.

FIG. 9B represents an example of an architecture of any of the client (e.g., processing) device 9A and the cloud server 9C described herein. The processing device 9A 9C may comprise one or more processor(s) 910, which may be, for example, any of a CPU, a GPU a DSP (English acronym of Digital Signal Processor), along with memory 920 (e.g. any of RAM, ROM, EPROM). The processing device 9A 9C may comprise any number of Input/Output interface(s) 930 adapted to send output information and/or to allow a user to enter commands and/or data (e.g. any of a keyboard, a mouse, a touchpad, a webcam, a display), and/or to send/receive data over a network interface; and a power source 940 which may be external to the processing device 9A.

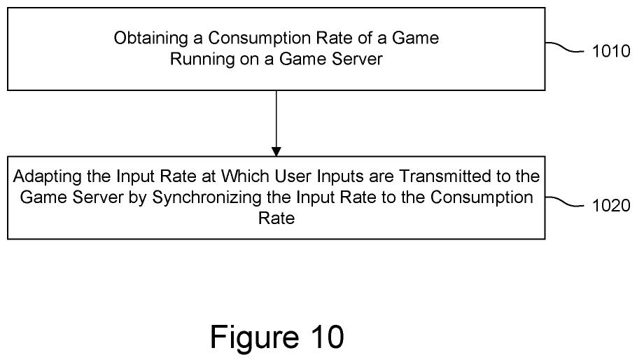

According embodiments, the processing device 9A 9C may further comprise a computer program stored in the memory 920. The computer program may comprise instructions which, when executed by the processing device 9A, in particular by the processor(s) 910, make the processing device 9A 9C carrying out the processing method described with reference to any of FIGS. 10, 11 and 12. According to a variant, the computer program may be stored externally to the processing device 9A 9C on a non-transitory digital data support, e.g. on an external storage medium such as any of a SD Card, HDD, CD-ROM, DVD, a read-only and/or DVD drive, a DVD Read/Write drive, all known in the art. The processing device 9A may comprise an interface to read the computer program. Further, the processing device 9A may access any number of Universal Serial Bus (USB)-type storage devices (e.g., “memory sticks.”) through corresponding USB ports (not shown).

According to embodiments, the processing device 9A 9C may be any of a game device, a set top box device, a TV set, a digital media player (e.g., renderer) device, an Internet gateway, a mobile device, a communication device, a tablet (or tablet computer), a smartphone, a laptop computer, a desktop computer, a server, for example capable of running one or more instances (e.g., of a game).

FIG. 9C is a diagram illustrating an example of a processing device 9C that may be configured as a cloud server. For example, the processing device 9C may comprise at least one instance configured to run a game instance in interaction with a client device. For example, the processing device 9C may comprise a network interface 91 for connection to a network. The network interface 91 may be configured to receive input information for the running game from a client device. Input information may include, for example, an (e.g., user) input commands that may be received from the client device. For example, the network interface 91 may be configured to transmit a video stream to the client device. The video stream may contain video frames of the game to be decoded and displayed by the client device. According to embodiments, the network interface 91 may be any of:
a wireless local area network interface such as Bluetooth, Wi-Fi in any flavour, or any kind of wireless interface of the IEEE 802 family of network interfaces;
a wired LAN interface such as Ethernet, IEEE 802.3 or any wired interface of the IEEE 802 family of network interfaces;
a wired bus interface such as USB, FireWire, or any kind of wired bus technology.
a broadband cellular wireless network interface such a 2G/3G/4G/5G cellular wireless network interface compliant to the 3GPP specification in any of its releases;
a wide area network interface such a xDSL, FFTx or a WiMAX interface.

More generally, any network interface allowing to receive input information for a running game and to transmit a video stream of the running game may be applicable to embodiments described herein.

According to embodiments, the network interface 91 may be coupled to a processing module 93, that may be configured to run at least one instance. For example, the at least one instance may be configured to execute a game. For example, the at least one instance may be configured to transmit video frames of the game to the client device. For example, the at least one instance may be configured to receive from the client device, via the network interface 91, input information for the running game. For example, the at least one instance may be configured to transmit, to the client device, consumption rate information representative of a processing rate at which the instance of the cloud server may process the received input information. For example, the processing of the received input information may result in further video frames of the game, that may be rendered, encoded and transmitted to the client device. For example, input information (based on which video frames of the game may be generated, rendered, encoded and transmitted) may be received at a receiving rate that may vary according to (e.g., a variation of) the processing rate at which the input information may be processed. For example, the processing rate of first input information (e.g., received at a first receiving rate) may vary (e.g., by any of increasing and decreasing) which may result in transmitting consumption rate information indicating (e.g., the variation of) the processing rate, which may result in a receiving second input information from the client device at a second receiving rate taking into account the indicated (e.g., variation of) the processing rate.

FIG. 10 is a diagram illustrating an example of a method for adapting an (e.g., user) input rate of at least one input device of a (e.g., cloud gaming) client device. According to embodiments, in a step 1010 a consumption rate of a game running on a game server may be obtained (e.g., by the client device). For example, the consumption rate may be associated with one of the at least one input device. For example, any number of consumption rates associated with respectively any number of input devices may be obtained (e.g., by the client device). For example, a consumption rate may be representative of a velocity (e.g., rate) at which the game server may react to (e.g., process) user inputs of the (e.g., associated) input device.

According to embodiments, in a step 1020, the input rate (e.g., at which the user inputs may be transmitted to the game server) may be adapted by synchronizing the input rate to the consumption rate.

For example, the consumption rate may be obtained from an information received from any of the game server and another (e.g., monitoring) server.

For example, the information may comprise any of an input consumption rate at which events may be consumed (e.g., processed) by the game, a game frame rate at which the game may be rendered by e.g., a game rendering thread, a server frame rate at which video frames of the game may be any of encoded and captured on the server, and a filling ratio of an input queue associated with the game. The input queue may be located in the game server instance that may be running the game. The input queue may include input events that may have been received from the client device and that may be waiting for being processed by the game running on the game server instance.

For example, the information may comprise a timestamp that may indicate occurrence at the game server of any of an input event and a frame rendering event.

For example, the information may comprise any of an average, a median, a maximum, a minimum and percentiles of any of the input consumption rate, the game frame rate and the server frame rate, for example, over a time interval.

For example, the information may comprise a predicted value for any of the input consumption rate, the game frame rate and the server frame rate.

For example, the information may be received on a regular basis.

For example, the information may be received on a condition that any of the input consumption rate, the game frame rate and the server frame rate changes.

For example, the information may be encapsulated in metadata of a video stream comprising video frames of the game.

For example, the consumption rate may be obtained based on a frame rate at which video frames of the game may be any of received and decoded by the (e.g., cloud gaming) client device.

For example, any of a polling rate of the user inputs and a sending rate of the user inputs to the game server may be set (e.g., synchronized) to the consumption rate. For example, different sets of user inputs may provide from different input devices. Different (e.g., polling, sending) rates of user inputs (corresponding to different input devices) may be set (e.g., synchronized) to respectively different consumption rates associated with the different input devices.

For example, a predicted consumption rate may be obtained based on a history of previous consumption rate information. For example, the input rate may be further adapted based on the predicted consumption rate.

For example, the predicted consumption rate may be received from the game server.

For example, the predicted consumption rate may be determined (e.g., computed) on the cloud gaming client based on the history of previous consumption rate information received from the game server.

For example, the history of previous consumption rate information may further comprise information representative of a load of the server.

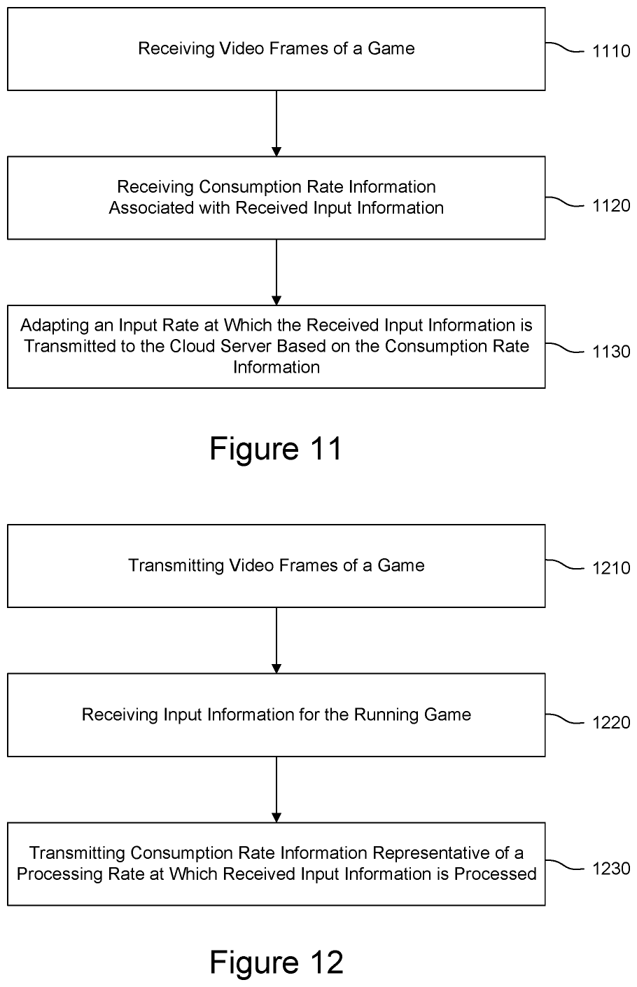

FIG. 11 is a diagram illustrating an example of a method implemented in a client device. For example, the method may comprise receiving 1110, from a cloud server, video frames of a game running on the cloud server. For example, the method may comprise receiving 1120 consumption rate information associated with the running game. For example, the consumption rate information may be associated with received input information from at least one input device of the client device. For example, the consumption rate information may be representative of a (e.g., processing) rate at which the received input information from the at least one input device may be processed by the cloud server. For example, the method may comprise adapting 1130 an input rate at which the received information may be transmitted to the cloud server, based on the received consumption rate information.

For example, receiving the consumption rate information may comprise determining a consumption rate value at the client device based on receiving and decoding the video frames received from the cloud server.

For example, the consumption rate information may be received from the cloud server and the consumption rate information may indicate a consumption rate value determined at the cloud server. For example, the consumption rate value may indicate the rate at which the received input information may be processed by the cloud server.

For example, the consumption rate information may be received from the cloud server and a consumption rate value may be determined at the client device based on the received consumption rate information. For example, the consumption rate value may be representative of the rate at which the received input information may be processed by the cloud server.

For example, adapting the input rate at which the received input information may be transmitted to the cloud server, may comprise synchronizing the input rate to the consumption rate value by setting any of (i) a sending rate of the received input information and (ii) a polling rate of the received input information.

For example, the consumption rate information may indicate any of (i) an input consumption rate (e.g., indicating the rate) at which the received input information may be processed by the running game, (ii) a game frame rate at which the running game may be rendered by a game rendering thread, (iii) a server frame rate at which the video frames of the running game may be any of encoded and captured on the cloud server, and (iv) a filling ratio of an input queue associated with the running game.

For example, the consumption rate information may comprise a timestamp indicating occurrence at the cloud server of any of an input event and a frame rendering event.

For example, the consumption rate information may indicate any of an average, a median, a maximum, a minimum and percentiles, over a time interval, of any of the input consumption rate, the game frame rate, the server frame rate and the filling ratio of the input queue.

For example, the consumption rate information may indicate a predicted value for any of the input consumption rate, the game frame rate, the server frame rate, and the filling ratio of the input queue.

For example, the consumption rate information may be received on a regular basis.

For example, the consumption rate information may be received on a condition that any of the input consumption rate, the game frame rate, the server frame rate and the filling ratio changes.

For example, the consumption rate information may be encapsulated in metadata of a video stream comprising the video frames of the running game.

For example, the method may further comprise receiving, from the cloud server, predicted consumption rate information representative of a predicted rate at which the cloud server may process further received input information, wherein the input rate may be adapted based on the predicted consumption rate information.

For example, the predicted consumption rate information may indicate a predicted consumption rate value determined at the cloud server, the predicted consumption rate value indicating the predicted rate at which the cloud server may process the further received input information.

For example, the predicted consumption rate value may be determined at the client device based on a history of previous consumption rate information received from the cloud server.

For example, the history of previous consumption rate information may further indicate a load of the cloud server.

FIG. 12 is a diagram illustrating an example of a method implemented in an instance of a cloud server. For example, the method may comprise transmitting 1210, to a client device, video frames of a game running on the instance of the cloud server. For example, the method may comprise receiving 1220, from the client device, input information for (e.g., associated with) the running game. For example, the method may comprise transmitting 1230, to the client device, consumption rate information representative of a processing rate at which the received input information may be processed by the instance of the cloud server. For example, the input information may be received at a receiving rate varying according to the processing rate.

For example, the consumption rate information may indicate any of (i) the processing rate at which the received input information may be processed by the instance of the cloud server, (ii) a game frame rate at which the running game may be rendered by the instance of the cloud server, (iii) a server frame rate at which the video frames of the running game may be any of encoded and captured by the instance of the cloud server, and (iv) a filling ratio of an input queue associated with the running game.

For example, the consumption rate information may comprise a timestamp indicating occurrence at the instance of the cloud server of any of an input event and a frame rendering event.

For example, the consumption rate information may indicate any of an average, a median, a maximum, a minimum and percentiles, over a time interval, of any of the processing rate, the game frame rate, the server frame rate and the filling ratio of the input queue.

For example, the consumption rate information may indicate a predicted value for any of the processing rate, the game frame rate, the server frame rate, and the filling ratio of the input queue.

For example, the consumption rate information may be transmitted on a regular basis.

For example, the consumption rate information may be transmitted on a condition that any of the processing rate, the game frame rate, the server frame rate and the filling ratio changes.

For example, the consumption rate information may be encapsulated in metadata of a video stream comprising the video frames of the running game.

For example, the method may further comprise determining a predicted consumption rate value based on a history of previous consumption rate information, the predicted consumption rate value indicating a predicted processing rate at which the instance of the cloud server may process further received input information.

For example, the transmitted consumption rate information may indicate the determined predicted consumption rate value.

For example, the method may further comprise transmitting, to the client device, a history of previous consumption rate information.

For example, the history of previous consumption rate information may further indicate a load of the cloud server.

### CONCLUSION

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a client device, user equipment, terminal, base station, or any host computer.

While not explicitly described, the present embodiments may be employed in any combination or sub-combination. For example, the present principles are not limited to the described variants, and any arrangement of variants and embodiments can be used. Moreover, the present principles are not limited to the described channel access methods and any other type of channel access methods is compatible with the present principles.

Besides, any characteristic, variant or embodiment described for a method is compatible with an apparatus device comprising means for processing the disclosed method, with a device comprising a processor configured to process the disclosed method, with a computer program product comprising program code instructions and with a non-transitory computer-readable storage medium storing program instructions.

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the representative embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (“RAM”)) or non-volatile (e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (e.g., but not always, in that in certain contexts the choice between hardware and software may become significant) a design choice representing cost vs. efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt fora mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such.

Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

It is also to be understood that the terminology used herein is for the purpose of describing particular embodiments only and is not intended to be limiting. As used herein, when referred to herein, the terms “station” and its abbreviation “STA”, “user equipment” and its abbreviation “UE” may mean (i) a wireless transmit and/or receive unit (WTRU), such as described infra; (ii) any of a number of embodiments of a WTRU, such as described infra; (iii) a wireless-capable and/or wired-capable (e.g., tetherable) device configured with, inter alia, some or all structures and functionality of a WTRU, such as described infra; (iii) a wireless-capable and/or wired-capable device configured with less than all structures and functionality of a WTRU, such as described infra; or (iv) the like. Details of an example WTRU, which may be representative of any UE recited herein, are provided below with respect to FIGS. 1A-1D.

In certain representative embodiments, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” or “group” is intended to include any number of items, including zero. Additionally, as used herein, the term “number” is intended to include any number, including zero.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

A processor in association with software may be used to implement a radio frequency transceiver for use in a wireless transmit receive unit (WTRU), user equipment (UE), terminal, base station, Mobility Management Entity (MME) or Evolved Packet Core (EPC), or any host computer. The WTRU may be used in conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the invention has been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

Throughout the disclosure, one of skill understands that certain representative embodiments may be used in the alternative or in combination with other representative embodiments.

1. A method implemented in a client device, the method comprising:
receiving, from a cloud server, video frames of a game running on the cloud server;
receiving input information from at least one input device of the client device, resulting from user interactions associated with the video frames;
transmitting the input information to the cloud server;
receiving consumption rate information associated with the running game, wherein the consumption rate information is representative of a rate at which the cloud server processes the input information; and
adapting an input rate at which the input information is transmitted to the cloud server based on the received consumption rate information.

2. The method of claim 1, wherein receiving the consumption rate information comprises determining a consumption rate value at the client device based on receiving and decoding the video frames received from the cloud server.

3. The method of claim 1, wherein the consumption rate information is received from the cloud server and wherein the consumption rate information indicates a consumption rate value at the cloud server, the consumption rate value indicating the rate at which the cloud server processes the received input information.

4. The method of claim 1, wherein the consumption rate information is received from the cloud server and wherein a consumption rate value is determined at the client device based on the received consumption rate information, the consumption rate value being representative of the rate at which the cloud server processes the received input information.

5. The method of claim 1, wherein adapting the input rate at which the received input information is transmitted to the cloud server comprises synchronizing the input rate to a consumption rate value by setting any of (i) a sending rate of the received input information and (ii) a polling rate of the received input information.

6. The method of claim 4, wherein the consumption rate information indicates any of:
an input consumption rate at which the received input information is processed by the running game,
a game frame rate at which the running game is rendered by a game rendering thread,
a server frame rate at which the video frames of the running game are any of encoded and captured on the cloud server, and
a filling ratio of an input queue associated with the running game.

7. The method of claim 4, wherein the consumption rate information comprises a timestamp indicating occurrence at the cloud server of any of an input event and a frame rendering event.

8-9. (canceled)

10. The method of claim 3, wherein the consumption rate information is received on a regular basis.

11. The method of claim 6, wherein the consumption rate information is received on a condition that any of the input consumption rate, the game frame rate, the server frame rate and the filling ratio changes.

12. The method of claim 3, wherein the consumption rate information is encapsulated in metadata of a video stream comprising the video frames of the running game.

13-14. (canceled)

15. The method of claim 1, wherein a predicted consumption rate value is determined at the client device based on a history of previous consumption rate information received from the cloud server.

16. (canceled)

17. A method implemented in an instance of a cloud server, the method comprising:
transmitting, to a client device, video frames of a game running on the instance of the cloud server;
receiving, from the client device, input information resulting from user interactions associated with the video frames of the running game; and
transmitting, to the client device, consumption rate information representative of a processing rate at which the instance of the cloud server processes the received input information;
wherein the input information is received at a receiving rate varying according to the processing rate.

18. The method of claim 17, wherein the consumption rate information indicates any of:
the processing rate at which the received input information is processed by the instance of the cloud server,
a game frame rate at which the running game is rendered by the instance of the cloud server,
a server frame rate at which the video frames of the running game are any of encoded and captured by the instance of the cloud server, and
a filling ratio of an input queue associated with the running game.

19. The method of claim 17, wherein the consumption rate information comprises a timestamp indicating occurrence at the instance of the cloud server of any of an input event and a frame rendering event.

20-21. (canceled)

22. The method of claim 17, wherein the consumption rate information is transmitted on a regular basis.

23. The method of claim 18, wherein the consumption rate information is transmitted on a condition that any of the processing rate, the game frame rate, the server frame rate and the filling ratio changes.

24. The method of claim 17, wherein the consumption rate information is encapsulated in metadata of a video stream comprising the video frames of the running game.

25. The method of claim 17, further comprising determining a predicted consumption rate value based on a history of previous consumption rate information, the predicted consumption rate value indicating a predicted processing rate at which the instance of the cloud server will for processing further received input information by the instance of the cloud server.

26. The method of claim 25, wherein the transmitted consumption rate information indicates the determined predicted consumption rate value.

27-30. (canceled)

31. A client device comprising circuitry, including any of a transmitter, a receiver, a processor and a memory, the client device being configured to:
receive, from a cloud server, video frames of a game running on the cloud server;
receive input information from at least one input device of the client device, resulting from user interactions associated with the video frames;
transmit the input information to the cloud server;
receive consumption rate information associated with the running game, wherein the consumption rate information is representative of a rate at which the cloud server processes the input information; and
adapt an input rate at which the input information is transmitted to the cloud server based on the received consumption rate information.
